(19) United States
(12) Patent Application Publication
(10) Pub. No.: US 2008/0043783 A1
(43) Pub. Date: Feb. 21, 2008

(54) Netphone and communication method therefor

(76) Inventors: Jui-Feng Chai, Taipei City (TW); Ting-Chang Kuo, Taipei City (TW); Hooi-Ling Yeo, Bayan Lepas (MY)

Correspondence Address: HARNESS, DICKEY & PIERCE, P.L.C., P.O. BOX 8910, RESTON, VA, 20195, US

(21) Appl. No.: 11/498,797

(22) Filed: Aug. 4, 2006

(51) Int. Cl. H04J 3/04

(52) U.S. Cl. 370/535

(57) ABSTRACT

A netphone and a communication method therefor are provided. The netphone comprises a main central processing unit, a video output module, an audio receiver, an audio output module, a ring generator, a command processing module, an input interface, a video capture module, a hang-up detection module, a storage module, a transceiver, and a network interface. The main central processing unit further comprises a multiplexer/demultiplexer, a video processing module, an audio processing module, a communication control module, and a system control module. The netphone may automatically establish a communication connection according to the user's command, and close the video communication at anytime, which is convenient for operation and protects personal privacy sufficiently.

### BACKGROUND OF THE INVENTION

1. Field of Invention

The present invention relates to a network communication device and a communication method therefor, and more particularly to a netphone and a communication method therefor.

2. Related Art

The Voice over Internet Protocol (VoIP) is a technique for transmitting audio communication with the addressing of the Internet, by using the network as medium, and the telephone device set according to the VoIP protocol is called a netphone. In early times, as the transmission speed of networks was limited, the voice of the counterpart was clear enough when a compression standard with low resolution was used, while when a compression standard with higher resolution was used, the file was excessively large and the transmit speed was slow, so that transmission of sound was intermittent, and not suitable for general use at all. However, with the popularity of the broadband network, sound sampling may be increased, thus it may approximate common telephone audio signals. Not only the sound, but the transmission of dynamic Real Player images with a sampling of 1000 k/sec can also be achieved, thus video systems have begun to be commonly used in the network.

As for the field of existing netphones, there are 3 types of video netphones, namely (1) computer-to-telephone, (2) computer-to-computer, and (3) telephone-to-telephone. The video netphones of the telephone-to-telephone type cannot be quickly popularized because of their expensive price and simple functions, thus it is required to provide a video netphone with strong functionality and convenient usage.

### SUMMARY OF THE INVENTION

According to one aspect of the present invention, a netphone is provided. The netphone comprises a main central processing unit, a video capture module, a video output module, an audio receiver, an audio output module, an input interface, a command processing module, a storage module, a transceiver, and a network interface.

According to another aspect of the invention, a communication method is provided. The communication method comprises: establishing a communication channel via the Internet; reading the setting for activating video; detecting the communication mode; capturing audio signals and/or video signals, processing the captured audio signals and/or video signals, and carrying out audio and/or video communication via the communication channel; closing the video communication when receiving the command for closing the video communication; and ending the communication when the communication channel is closed.

Accordingly, it is an object of the present invention to provide a netphone and communication method. The netphone can automatically establish the communication connection by inputting commands, and close the video communication at anytime, which is convenient for operation and protects personal privacy sufficiently.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow for illustration only, and which thus is not limitative of the present invention, and wherein:

FIG. 1 is a block diagram of the structure of netphones according to the present invention;

FIG. 2 is a topologic view of the network of netphones according to the present invention;

FIG. 3 a flow chart of a communication method of the present invention;

FIG. 4 is a processing flow chart when the command for closing the video communication is received according to the communication method of the present invention;

FIG. 5 is a flow chart of a method for establishing communication channels according to the present invention;

FIG. 6 is a flow chart of a method for processing data according to the communication method of the present invention;

FIG. 7 is a processing flow chart of detecting an incoming call/outgoing call according to the present invention;

FIG. 8 is a flow chart of a method for establishing an incoming call communication according to the present invention;

FIG. 9 is a flow chart of a method for establishing an outgoing call communication according to the present invention;

FIG. 10 is a flow chart of processing the data of an outgoing call communication according to the present invention;

FIG. 11 is a flow chart of processing the data of an incoming call communication according to the present invention; and

FIG. 12 is a flow chart of a method for carrying out communication in the privacy mode of the present invention.

### DETAILED DESCRIPTION OF THE INVENTION

Hereinafter, the preferred embodiments of the present invention will be illustrated in detail in combination with the accompanying drawings.

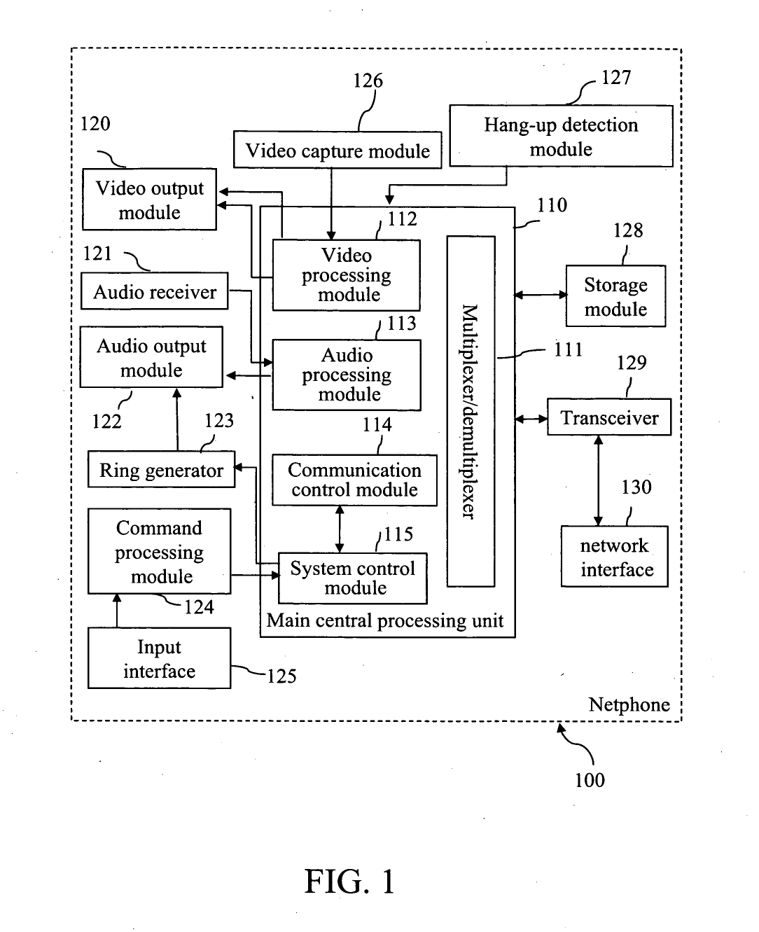

As shown in FIG. 1, it is a block diagram of the structure of a netphone 100 according to the present invention. The netphone comprises a main central processing unit 110, a video output module 120, an audio receiver 121, an audio output module 122, a ring generator 123, a command processing module 124, an input interface 125, a video capture module 126, a hang-up detection module 127, a storage module 128, a transceiver 129, and a network interface 130.

The main central processing unit 110 further comprises a multiplexer/demultiplexer 111, a video processing module 112, an audio processing module 113, a communication control module 114, and a system control module 115.

The main central processing unit 110 is used to monitor, control, and process the operation of the netphone 100. The multiplexer/demultiplexer 111 is used to multiplex the video signals, audio signals, data, and control channels need to be transmitted into a single bit string, and transmit this single bit string to the transceiver 129. When a single bit string transmitted by the transceiver 129 is received, the multiplexer/demultiplexer 111 demultiplexes the received single bit string into corresponding media channels, and transmits the corresponding processing module. The multiplexer/demultiplexer 111 is also used to detect the error of transmitted data, and correct the detected error by way of re-transmission.

The video processing module 112 is used to encode the analog video signals captured by the video capture module 126 into the digital video signals, compress the encoded digital video signals, and transmit the compressed digital video signals to the multiplexer/demultiplexer 111. When digital video signals transmitted by the multiplexer/demultiplexer 111 are received, the video processing module 112 decompresses the received digital video signals, decodes the decompressed digital video signals into the analog video signals, and transmits the decoded analog video signals to the video output module 120. The video processing module 112 supports related video compression formats, for example, the standard compression formats H.263, H.264 made by the International Telecommunication Union (ITU), or standards related to video compression aiming at applications of multimedia, such as the MPEG 4 format, made by the Moving Pictures Expert Group (MPEG), an organization in the International Standard Organization (ISO). The audio processing module 113 is used to encode the analog audio signals received by the audio receiver 121 into the digital audio signals, compress the encoded digital audio signals, and transmit the compressed digital audio signals to the multiplexer/demultiplexer 111. When digital audio signals transmitted by the multiplexer/demultiplexer 111 are received, the audio processing module 113 decompresses the received digital audio signals, decodes the decompressed digital audio signals into the analog audio signals, and transmits the decoded analog audio signals to the audio output module 122. Moreover, the audio processing module 113 is also used to eliminate noises and resonances, so as to improve the speech quality of a netphone.

The communication control module 114 is used to control the establishment of video and/or audio communication connection with a remote netphone. The system control module 115 is used to control the operation of netphone 100, such as receiving user's commands transmitted by the command processing module 124, controlling the video capture module 126 to capture or stop capturing video signals according to the commands, and activating automatic video communication; determining the type of received call request, and controlling the communication control module 114 to establish video communication and/or audio communication connections according to the type of call request.

The video capture module 126 captures dynamic images of the user via a viewfinder (not shown), and transmits the obtained analog video signals to the video processing module 112. The video output module 120 receives the analog video signals transmitted by the video processing module 112, and displays them to the user via a display apparatus (not shown), such as a liquid crystal display. The audio receiver 121 receives voice signals of the user via an audio input/output apparatus (not shown), such as a mike and a microphone, and transmits the received analog audio signals to the audio processing module 113. When the netphone 100 receives a call, the ring generator 123 generates a ring according to the signals transmitted by the system control module 115 of the main central processing unit 110, and transmits the ring to the audio output module 122. The audio output module 122 receives the analog audio signals transmitted by the audio processing module 113 or the ring transmitted by the ring generator 123, and outputs corresponding audio signals via the audio input/output apparatus, such as a loudspeaker.

The input interface 125 is an input apparatus (such as a keyboard), which is used for the user to input commands, and transmitting the commands to the command processing module 124. The command processing module 124 translates the received commands, and delivers the translated commands to the system control module 115 of the main central processing unit 110. The system control module 115 performs the corresponding commands or stores the command parameters to the storage module 128. The storage module 128 is a storage medium (such as a magnetic disk), which is used to temporarily or permanently store data, program codes, and various command parameters. The hang-up detection module 127 is used to detect the hang-up or lift-up operation of the user to the audio input/output apparatus, and transmit corresponding signals to the system control module 115.

When a user presses down a button (not shown) set at the input interface 125 for automatically activating video communication, the input interface 125 delivers the command to the command processing module 124. The command processing module 124 transmits the translated command to the system control module 115. The system control module 115 stores the corresponding command parameters to the storage module 128. When the netphone 100 begins communication, the system control module 115 controls the communication control module 114 to automatically establish video communication according to the parameters. When the user inputs a command for activating the privacy mode via the input interface 125, the command processing module 124 translates the command received via the input interface 125, and transmits the translated command to the system control module 115. The system control module 115 stores the corresponding command parameters to the storage module 128. When the netphone 100 carries out communication, the system control module 115 controls the video capture module 126 to stop capturing video signals according to the parameters, so that the netphone 100 only carries out audio communication. When the command for releasing the privacy mode input by the user is received, the system control module 115 activates the video capture module 126 to capture video signals, so that the netphone 100 carries out both the audio and video communications.

The network interface 130 is used for the communication of the netphone 100 with a remote netphone via the Internet. The transceiver 129 partitions the single bit string transmitted by the multiplexer/demultiplexer 111 into a plurality of data segments, and packages each data segment and necessary delivered information into a data package, and transmits the data package to the remote netphone via the network interface 130. When the data package is received via the network interface 130, the transceiver 129 depackages the received data package into data segments, and integrates the plurality of data segments into a single bit string, and transmits this single bit string to the multiplexer/demultiplexer 111.

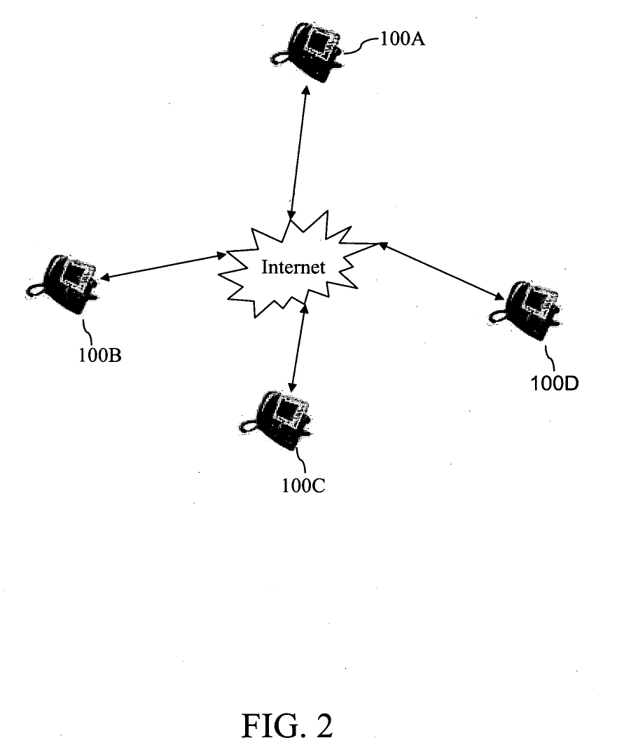

As shown in FIG. 2, it is a topologic view of a network of netphones according to the present invention. As shown in the drawing, the netphones 100A, 100B, 100C, and 100D having the above-mentioned structure of the present invention may perform point-to-point or point-to-multipoint communication via the Internet.

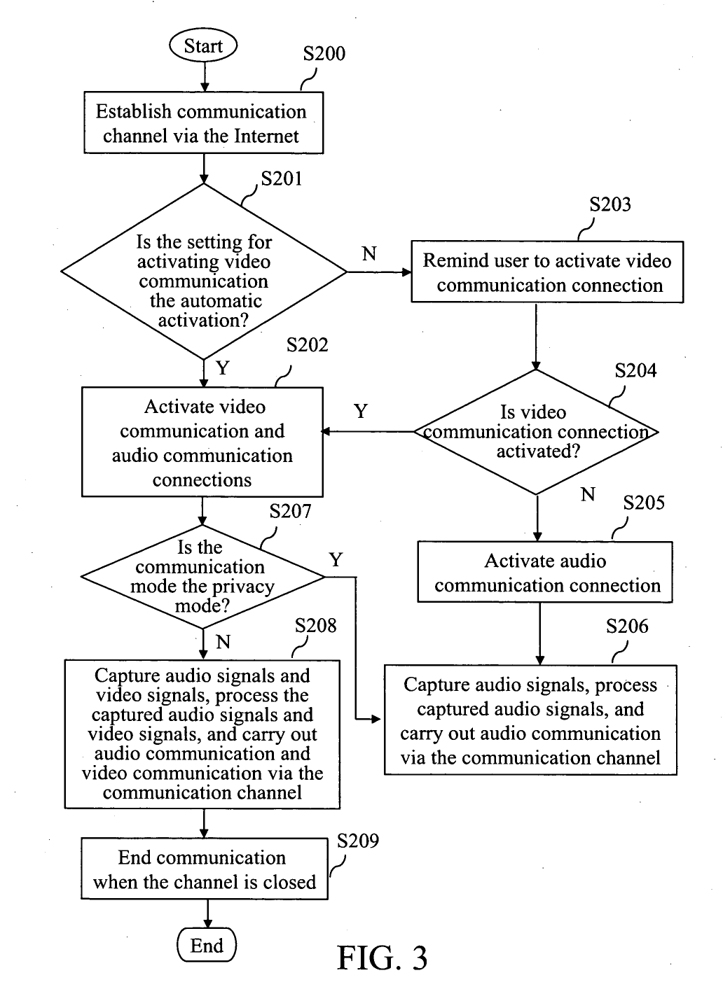

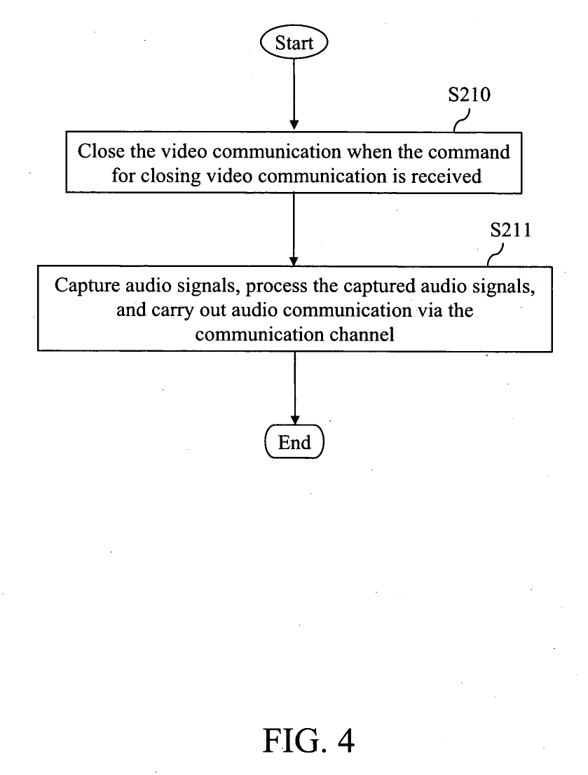

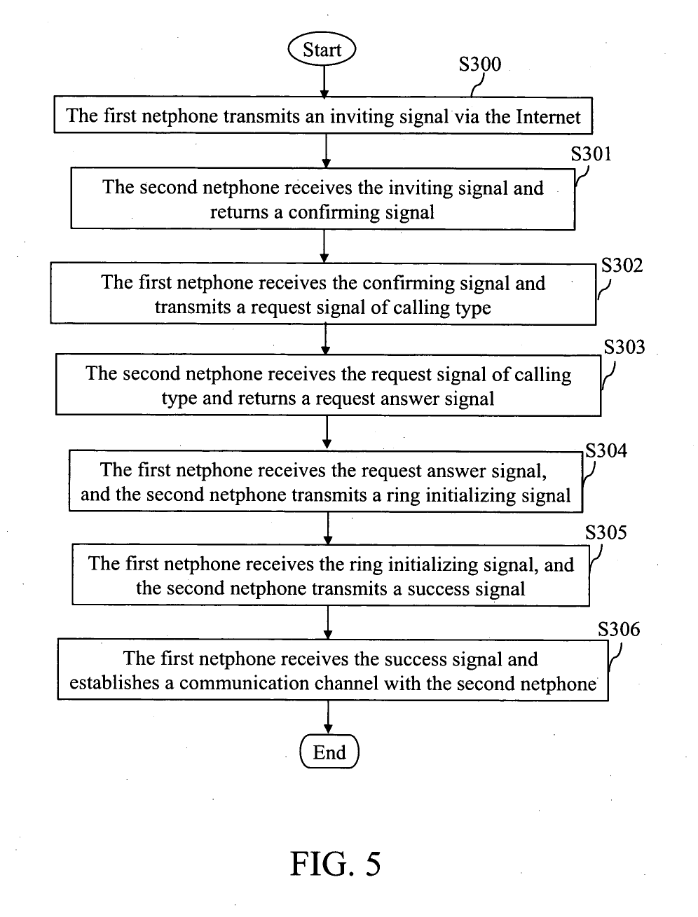

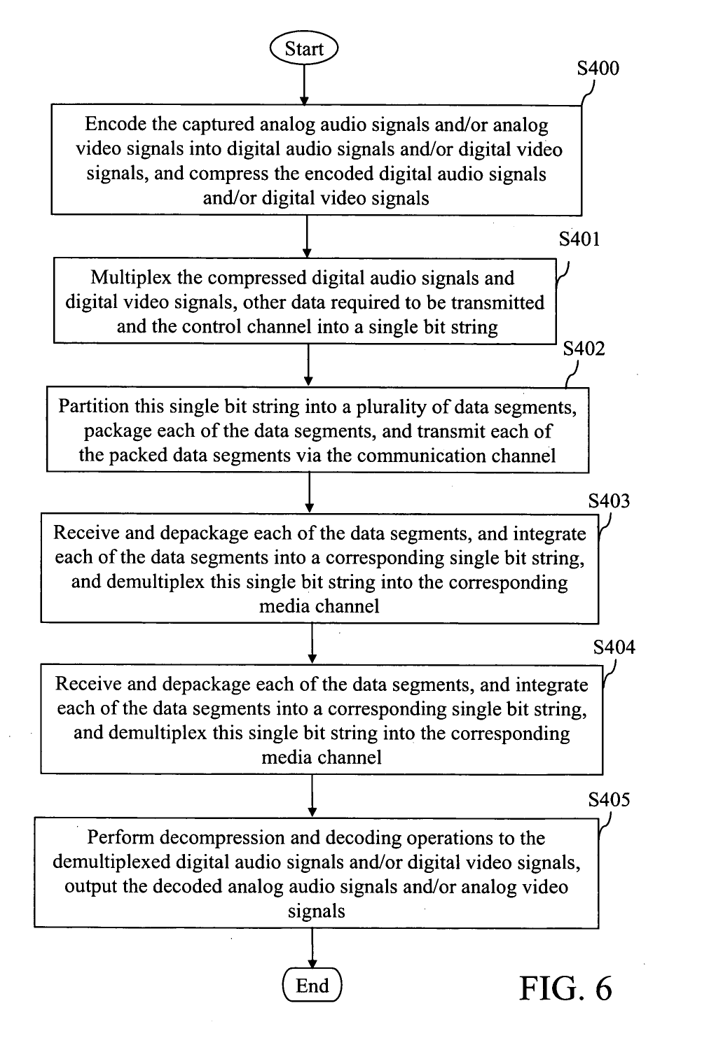

As shown in FIGS. 3, 4, 5, and 6, FIG. 3 is a flow chart of a communication method of the present invention, FIG. 4 is a processing flow chart when the command for closing video communication is received according to the communication method of the present invention, FIG. 5 is a flow chart of a method for establishing a communication channel between two netphones 100A and 100B of the present invention, and FIG. 6 is a flow chart of a method for processing data according to the communication method of the present invention.

As shown in the drawings, this method comprises the following steps.

First, the netphone 100 establishes a communication channel with a remote netphone via the Internet (step S200), which further comprises performing a series of negotiations among netphones for establishing the communication channel (as shown in FIG. 5). First, the netphone 100A transmits an inviting signal to the Internet. The Internet receives the inviting signal, and transmits the inviting signal to the netphone 100B in the name of the netphone 100A (step S300). After the netphone 100B receives the inviting signal transmitted by the Internet, it accepts the invitation, and returns a confirming signal to the Internet (step S301). Also, the Internet transmits the received confirming signal to the netphone 100A in the name of the netphone 100B. After the netphone 100A receives the confirming signal, it will negotiate with the netphone 100B about the calling type and format. Therefore, the netphone 100A transmits a request signal of the calling type to Internet (step S302). The Internet receives the request signal of the calling type and transmits it to the netphone 100B. After the netphone 100B receives the request signal of the calling type, it checks whether this calling type is compatible with the format. When the calling type is compatible with the format, the netphone 100B returns a request answer signal to the Internet (step S303). The Internet transmits the request answer signal to the netphone 100A, to inform the netphone 100A that its request is accepted by the netphone 100B. Meanwhile, the netphone 100B transmits a ring initializing signal to the Internet (step S304). The netphone 100A receives the ring initializing signal via the Internet. This ring initializing signal indicates that the communication channel of the netphone 100B has been opened and is ready for establishing connection. After the netphone 100A receives the ring initializing signal, the netphone 100B outputs a ring, and detects the operation of the user. When the user lifts up the microphone, the netphone 100B transmits a success signal to Internet (step S305). The Internet receives and transmits the success signal to the netphone 100A. The netphone 100A receives the success signal and establishes a communication channel with the netphone 100B (step S306).

Next, read the setting for activating video communication stored in the netphone 100, and determine whether the setting for activating video communication is the automatic activation (step S201). When the setting for activating video communication is automatic activation, the netphone 100 activates video communication and audio communication connections (step S202); when the setting for activating video communication is manual activation, the netphone 100 reminds the user to activate the video communication connection (step S203). Determine whether the video communication connection is activated according to the command input by the user (step S204). When the user inputs the activation command, the netphone 100 activates the video communication and audio communication connections (step S202); otherwise, the netphone 100 only activates the audio communication connection (step S205). Further, the netphone should capture audio signals, process captured audio signals, and carry out audio communication via the communication channel (step S206). After the netphone 100 activates video communication and audio communication connections (step S202), the netphone 100 detects communication mode, and determines whether the communication mode is the privacy mode (step S207). When the communication mode is the privacy mode, the netphone 100 captures audio signals, processes the captured audio signals, and carries out audio communication via the communication channel (step S206), otherwise, the netphone 100 captures audio signals and video signals, processes the captured audio signals and video signals, and carries out audio communication and video communication via the communication channel (step S208).

The step of processing the captured audio signals and/or video signals, and carrying out audio communication and/or video communication via the communication channel further comprises the following steps (as shown in FIG. 6). Encode the captured analog audio signals and/or analog video signals into digital audio signals and/or digital video signals, and compress the encoded digital audio signals and/or digital video signals (step S400). The encoding format of digital video signals supports related video compression format, for example, the standard compression formats H.263, H.264 made by the ITU, or standards related to video compression aiming at applications of multimedia, such as the MPEG 4 format, made by the MPEG, an organization in the ISO. The compressed digital audio signals and digital video signals and other data required to be transmitted, and the control channels are further multiplexed into a single bit string (step S401). This single bit string is partitioned into a plurality of data segments, each of which is packaged with necessary delivered information into a data package, and each data package is transmitted via the communication channel (step S402). When each data package is received via the communication channel, it is depackaged into data segments, then each data segment is integrated into a corresponding single bit string, and this single bit string is demultiplexed into the corresponding media channel (step S403). The demultiplexed digital audio signals and/or digital video signals are decompressed, the decompressed digital audio signals and/or digital video signals are decoded into analog audio signals and/or analog video signals, and the decoded analog audio signals and/or analog video signals are output (step S404).

As shown in FIG. 4, during the process of the audio communication and video communication of the netphone 100, whenever the command for closing the video communication input by user is received, the netphone 100 stops capturing video signals and closes the video communication (step S210). Thus the netphone 100 only captures audio signals, processes the captured audio signals, and carries out audio communication via the communication channel (step S211).

Last, when any one netphone in communication closes the communication channel, the netphone 100 ends the communication (step S209).

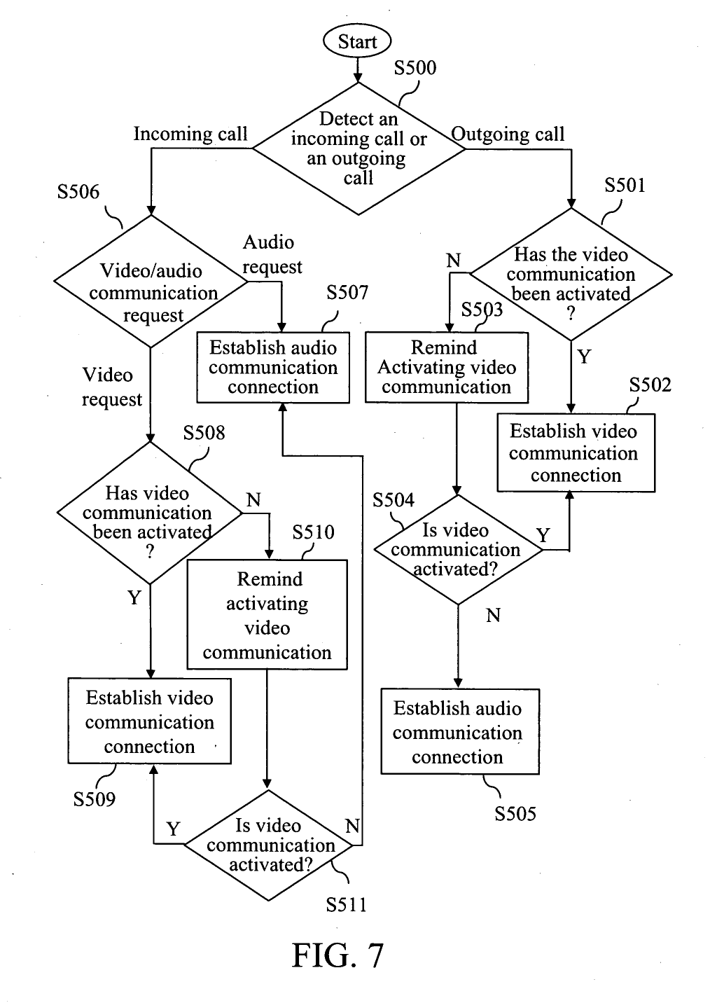

Now, as shown in FIG. 7, it is a processing flow chart of the netphone 100 of the present invention when it detects an incoming call/outgoing call. The netphone 100 detects whether there is an incoming call or an outgoing call (step S500). When an outgoing call is detected, the netphone 100 reads the stored command parameters of user, checks whether the video communication has been activated (step S501). When the video communication has been activated, the netphone 100 begins to establish video communication connection (step S502). When the video communication is not activated, the netphone 100 reminds the user to activate video communication (step S503). Determine whether the user chooses to activate video communication (step S504). When the user chooses to activate video communication, the netphone 100 begins to establish video communication connection (step S502); when the user does not choose to activate video communication, the netphone 100 begins to establish audio communication connection (step S505). When an incoming call is detected, determine whether the communication request is a video request or an audio request (step S506). When the communication request is an audio request, the netphone 100 establishes audio communication connection (step S507); when the communication request is a video request, determine whether the video communication has been activated (step S508). When the video communication has been activated, establish video communication connection (step S509), otherwise, remind the user to activate video communication (step S510). Determine whether the user chooses to activate video communication (step S511). When the user chooses to activate video communication, the netphone 100 begins to establish video communication connection (step S509); when the user does not choose to activate video communication, the netphone 100 begins to establish audio communication connection (step S507).

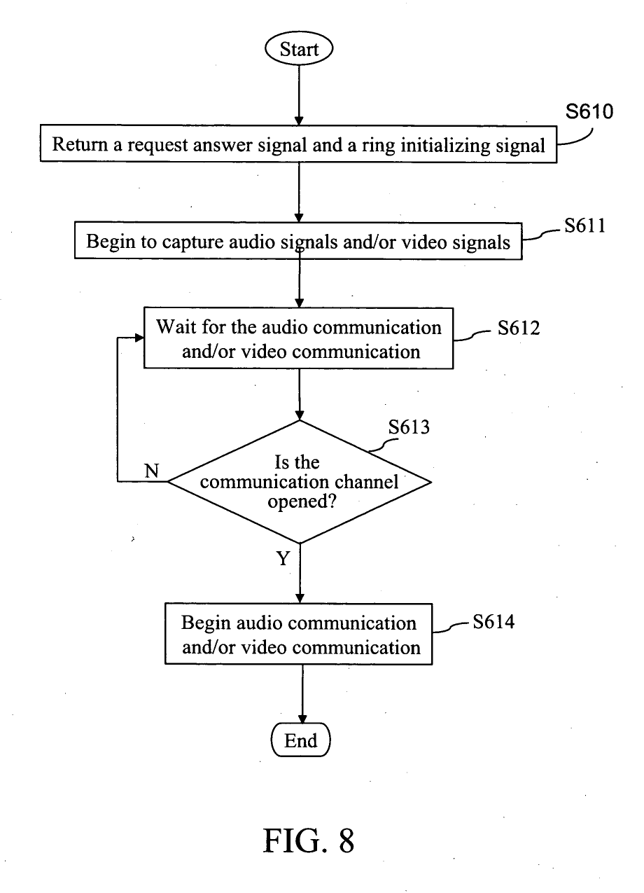

As shown in FIG. 8, it is a flow chart of a method for establishing an incoming call communication of the netphone 100 of the present invention. In the negotiating process of establishing the communication channel as shown in FIG. 5, after the netphone 100 detecting an incoming call returns a request answer signal and a ring initializing signal (step S610), the netphone 100 begins to capture audio signals and/or video signals according to the processing method shown in FIG. 7 (step S611), and waits for the audio communication and/or video communication (step S612). Next, determine whether the communication channel has been opened (step S613). While the communication channel is not opened, continue to wait for the audio communication and/or video communication (step S612). After the communication channel is opened according to the method shown in FIG. 5, the netphone 100 begins the audio communication and/or video communication with the remote netphone (step S613).

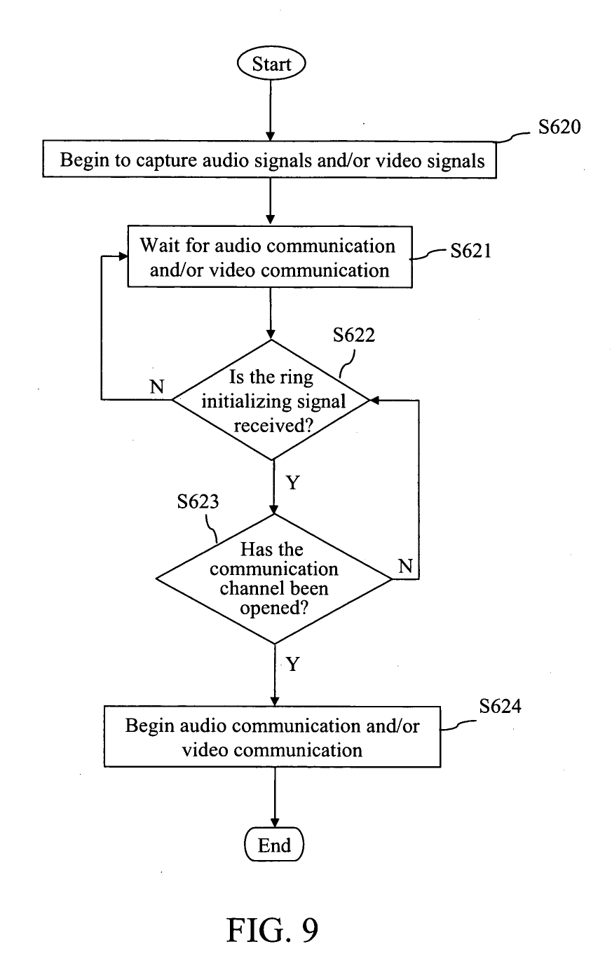

As shown in FIG. 9, it is a flow chart of a method for establishing an outgoing call communication of the netphone 100 of the present invention. After the netphone 100 transmits a call invitation to the remote netphone via the Internet, it begins to capture audio signals and/or video signals according to the method shown in FIG. 7 (step S620), and waits for audio communication and/or video communication (step S621). Next, determine whether the ring initializing signal transmitted by the netphone being called is received (step S622). While the ring initializing signal is not received, continue to wait for the audio communication and/or video communication (step S621); when the ring initializing signal is received, further determine whether the communication channel has been opened (step S623). While the communication channel is not opened, continue to wait for the opening of the communication channel. After the communication channel is opened according to the method shown in FIG. 5, the netphone 100 begins the audio communication and/or video communication with the netphone being called (step S624).

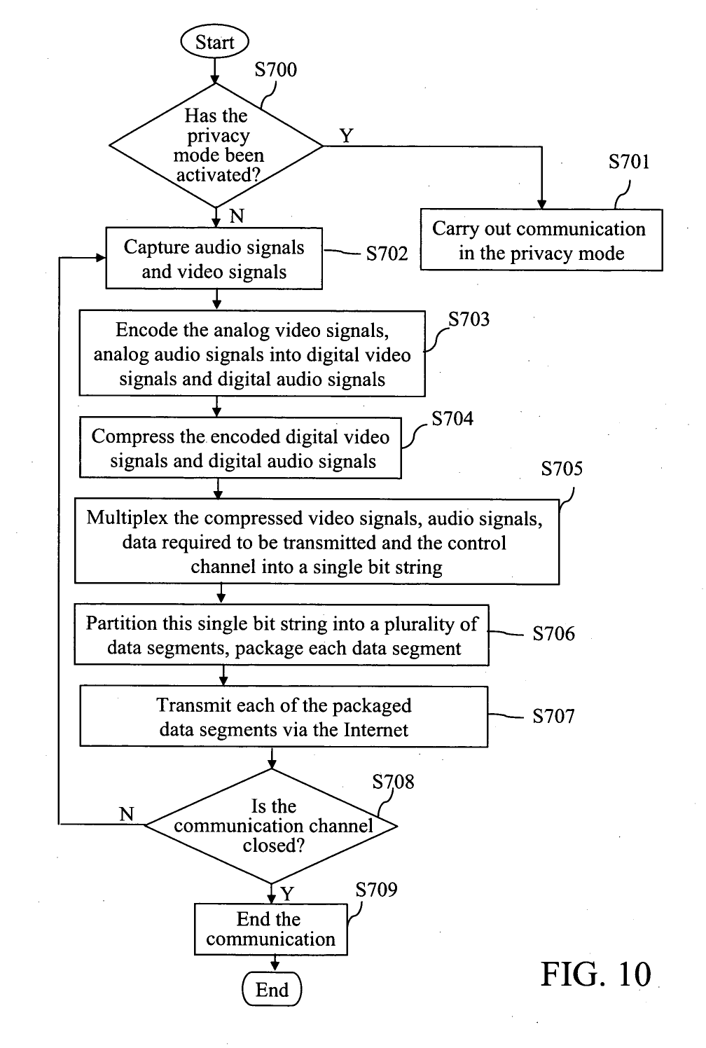

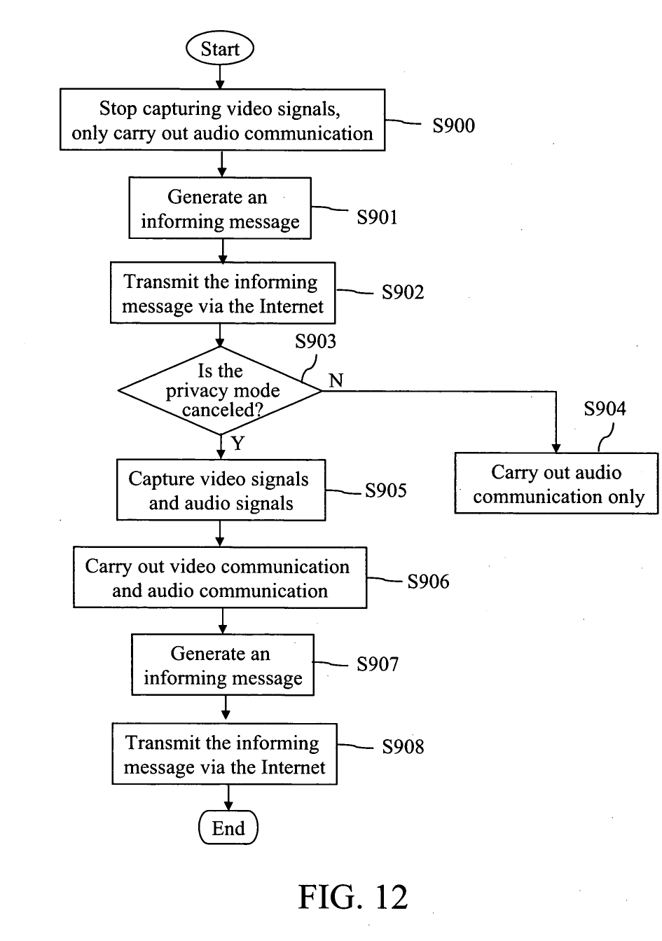

As shown in FIG. 10, it is a flow chart of processing the data of an outgoing call communication of the netphone 100 of the present invention. After the netphone 100 begins the communication with the netphone being called according to the method shown in FIG. 9, the netphone 100 reads the stored parameters, and determines whether it is in the privacy mode (step S700). When the netphone 100 is in the privacy mode, use the privacy mode to carry out the communication (referring to FIG. 12) (step S701); when the netphone 100 is not in the privacy mode, begin to capture audio signals and video signals (step S702). Encode the captured analog video signals and analog audio signals into digital video signals and digital audio signals (step S703). Compress the encoded digital video signals and digital audio signals (step S704). Multiplex the compressed digital video signals, digital audio signals, other data required to be transmitted, and the control channel into a single bit string (step S705). Partition this single bit string into a plurality of data segments. Package each data segment with necessary delivered information into a data package (step S706). Transmit the data package to the netphone being called via the Internet (step S707). During the process of communication with the netphone being called, the netphone 100 detects whether the communication channel is closed from time to time (step S708). If the communication channel is not closed, continue to perform step S700. When it is detected that the communication channel is closed, no matter whether the communication channel of the netphone 100 is closed or the communication channel of the netphone being called is closed, the netphone 100 ends the communication with the netphone being called (step S709).

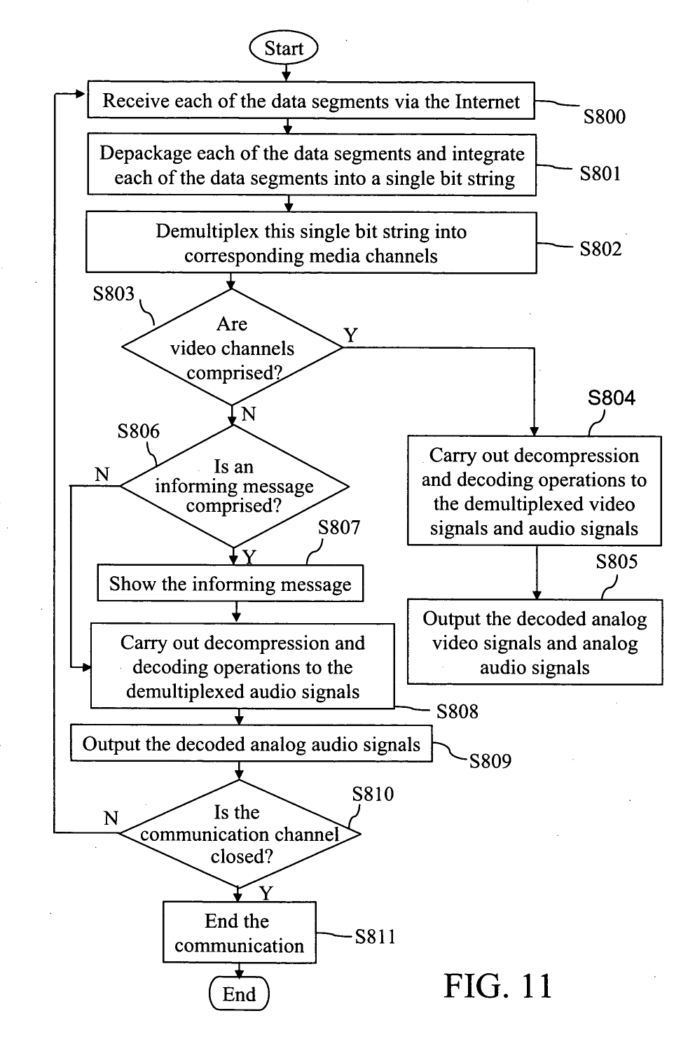

As shown in FIG. 11, it is a flow chart of processing the data of an incoming call communication of the netphone 100 of the present invention. After the netphone 100 begins the communication with the calling netphone according to the method shown in FIG. 8, the netphone 100 receives each data package transmitted by the calling netphone via Internet (step S800), depackages each data package into corresponding data segments, integrates the depackaged data segments into a single bit string (step S801), and demultiplexes this single bit string into corresponding media channels (step S802). Determine whether the demultiplexed media channels comprise video channels (step S803). When they comprise video channels, carry out decompression operation to the demultiplexed digital video signals and digital audio signals, and decode the decompressed digital video signals and digital audio signals into analog video signals and analog audio signals (step S804). Output the decoded analog video signals and analog audio signals (step S805). When the demultiplexed media channels do not comprise video channels, determine whether the media channels comprise an informing message for the calling netphone choosing the privacy mode (step S806). When they comprise the informing message, show the informing message to the user (step S807), otherwise, carry out decompression operation to the demultiplexed digital audio signals, and decode the decompressed digital audio signals into analog audio signals (step S808). Output the decoded analog audio signals (step S809). During the process of communication with the calling netphone, the netphone 100 detects whether the communication channel is closed from time to time (step S810). If the communication channel is not closed, continue to perform step S800. When it is detected that the communication channel is closed, no matter the communication channel of the netphone 100 is closed or the communication channel of the calling netphone is closed, the netphone 100 ends the communication with the calling netphone (step S811).

As shown in FIG. 12, it is a flow chart of a method for carrying out communication in the privacy mode of the present invention. When the netphone 100 enters the privacy mode according to the command of user, the netphone 100 stops capturing video signals, only carries out audio communication with the remote netphone (step S900). Meanwhile, the netphone 100 generates an informing message to inform that the privacy mode of the netphone 100 has been activated (step S901), and transmits the informing message to the remote netphone via the Internet (step S902). The netphone 100 detects from time to time whether the user has cancelled the privacy mode (step S903). While the privacy mode is not canceled, the netphone 100 continues the audio communication with the remote netphone (step S904). Otherwise, the netphone 100 recaptures video signals and audio signals (step S905), and carries out video and audio communications with the remote netphone (step S906). Meanwhile, the netphone 100 generates an informing message to inform that the privacy mode of the netphone 100 is canceled (step S907), and transmits the informing message to the remote netphone via Internet (step S908).

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A netphone, comprising:
a main central processing unit for controlling the operation of the netphone, performing the digital and analog conversion, compression and decompression, and multiplexing and demultiplexing operations to the received video signals and audio signals, and making the netphone automatically activate video communication according to the command of a user and set the netphone in a privacy mode;
a video capture module for capturing the dynamic images of the user and transmitting the captured video signals to the main central processing unit;
a video output module for outputting the video signals transmitted by the main central processing unit;
an audio receiver for receiving the audio data of the user and transmitting the received audio signals to the main central processing unit;
an audio output module for outputting the audio signals;
an input interface for the user to input commands;
a command processing module for translating the commands input by the user via the input interface, and transmitting the translated commands to the main central processing unit;
a storage module for storing data, program codes, and parameters;
a transceiver for partitioning, packaging, and transmitting the signals delivered by the main central processing unit, or receiving, depackaging, and integrating the signals delivered from the Internet; and
a network interface for connecting the netphone to the Internet.

2. The netphone as claimed in claim 1, wherein the netphone further comprises:
a hang-up detection module for detecting the user's hang-up or lift-up operation and transmitting the corresponding signals to the main central processing unit; and
a ring generator for generating a ring according to the signals transmitted by the main central processing unit and transmitting the ring to the audio output module.

3. The netphone as claimed in claim 1, wherein the main central processing unit further comprises:
a demultiplexer/multiplexer for multiplexing the video, the audio, the data, and the control channel into a single bit string, and transmit the single bit string, or demultiplexing a received single bit string into corresponding multimedia channels;
a video processing module for encoding the analog video signals captured by the video capture module into digital video signals, and compressing the encoded digital video signals, or decompressing received digital video signals, and decoding the decompressed digital video signals into analog video signals, and transmitting the decoded analog video signals to the video output module;
an audio processing module for encoding the analog audio signals received by the audio receiver into digital audio signals, and compressing the encoded digital audio signals, or decompressing received digital audio signals, and decoding the decompressed digital audio signals into analog audio signals, and transmitting the decoded analog audio signals to the audio output module;
a communication control module for controlling the communication of the netphone; and
a system control module for controlling the operation of the netphone.

4. The netphone as claimed in claim 1, wherein the privacy mode only carries out audio communication.

5. A communication method for carrying out communication of a plurality of netphones via the Internet, comprising:
establishing a communication channel via the Internet;
reading a setting for activating video communication, wherein when the setting for activating video communication is automatic activation, video communication connection is automatically activated, when the setting for activating video communication is manual activation, a user is reminded to activate the video communication connection;
detecting a communication mode, wherein when the communication mode is a privacy mode, the video communication is closed; otherwise, the video communication is activated;
capturing audio signals and/or video signals according to the communication mode, processing the captured audio signals and/or video signals, and carrying out audio and/or video communication via the communication channel;
closing the video communication when a command for closing video communication is received; and
ending the communication when the communication channel is closed.

6. The communication method as claimed in claim 5, wherein the step of establishing a communication channel via the Internet for establishing the communication channel between a first netphone and a second netphone, further comprises:
transmitting an inviting signal from the first netphone via the Internet;
receiving the inviting signal and returning a confirming signal from the second netphone;
receiving the confirming signal and transmitting a request signal of calling type from the first netphone;
receiving the request signal of calling type and returning a request answer signal from the second netphone;
receiving the request answer signal from the first netphone, and transmitting a ring initializing signal from the second netphone;
receiving the ring initializing signal from the first netphone, and transmitting a success signal from the second netphone; and
receiving the success signal from the first netphone and establishing a communication channel with the second netphone.

7. The communication method as claimed in claim 5, wherein the step of capturing audio signals and/or video signals according to the communication mode, processing the captured audio signals and/or video signals, and carrying out audio and/or video communication via the communication channel, further comprises:
encoding the captured analog audio signals and/or analog video signals into digital audio signals and/or digital video signals, and compressing the encoded digital audio signals and/or digital video signals;
multiplexing the compressed digital audio signals, digital video signals, data required to be transmitted, and the control channel into a single bit string;
partitioning the single bit string into a plurality of data segments, packaging each of the data segments, and transmitting each of the packaged data segments via the communication channel;
receiving and depackaging each of the data segments, and integrating each of the data segments into a single bit string, and demultiplexing the single bit string into corresponding media channels; and
performing decompression and decoding operations to the demultiplexed digital audio signals and/or digital video signals, and outputting the decoded analog audio signals and/or analog video signals.
